(19) United States
(12) Patent Application Publication
(10) Pub. No.: US 2019/0296930 A1
(43) Pub. Date: Sep. 26, 2019

(54) REMOTE CONTROL OF AN ASSISTANT DEVICE USING AN ADAPTABLE USER INTERFACE

(71) Applicant: Essential Products, Inc., Palo Alto, CA (US)

(72) Inventors: Manuel Roman, Sunnyvale, CA (US); Morten Torkildsen, Sunnyvale, CA (US); Shobhit Gupta, Milpitas, CA (US)

(21) Appl. No.: 15/974,379

(22) Filed: May 8, 2018

Related U.S. Application Data
(60) Provisional application No. 62/645,312, filed on Mar. 20, 2018.

(51) Int. Cl. H04L 12/28; H04L 29/06; H04L 29/08; G06F 3/0484; G06F 3/14; H04M 1/725

(52) U.S. Cl. CPC H04L 12/282; H04L 69/22; H04L 67/36; G06F 3/0483; G06F 3/1423; H04M 1/72533; G06F 3/04845

(57) ABSTRACT

Presented here are systems and methods to enable a user to remotely control the assistant device even when the user is not at home. The remote communication is established by creating a tunnel between the assistant device, the remote device and a cloud computer. The cloud computer provides the remote device with the same user interface that the assistant device displays. In turn, the remote device, via the cloud computer, provides commands to the assistant device. The user interface is adaptable, and once designed, is automatically adjusted to fit various display sizes of the assistant device and the remote device.

### CROSS-REFERENCE TO RELATED APPLICATIONS

This application claims priority to the U.S. Provisional Application Ser. No. 62/645,312, filed Mar. 20, 2018, and incorporated herein by this reference in its entirety.

### TECHNICAL FIELD

The present application is related to a home assistant device, and more specifically to methods and systems that enable remote control of a home assistant device using adaptable user interface.

### BACKGROUND

Assistant devices such as Google home and Alexa allow a user to control other appliances enabled for electronic communication. Once the user leaves home, however, access to the user's assistant device can be limited. Some assistant devices prevent communication with the assistant device, unless the remote device (such as the user's cell phone) is on the same local network as the assistant device.

### SUMMARY

Presented here are systems and methods to enable a user to remotely control the assistant device even when the user is not at home. The remote communication is established by creating a communication channel between the assistant device, the remote device and a cloud computer. The cloud computer provides the remote device with the same user interface that the assistant device displays. In turn, the remote device, via the cloud computer, provides commands to the assistant device. The user interface is adaptable, and once designed, is automatically adjusted to fit various display sizes of the assistant device and the remote device.

### BRIEF DESCRIPTION OF THE DRAWINGS

These and other objects, features and characteristics of the present embodiments will become more apparent to those skilled in the art from a study of the following detailed description in conjunction with the appended claims and drawings, all of which form a part of this specification. While the accompanying drawings include illustrations of various embodiments, the drawings are not intended to limit the claimed subject matter.

FIG. 1 shows an assistant device interacting with other home devices.

FIG. 2 shows a system enabling the assistant device to interact with a second device associated with the user when the second device and the user are not at home.

FIG. 3 shows an example of an adaptable user interface.

FIGS. 4A-4B show an adaptable user interface on various displays.

FIG. 5 shows a design of a software application.

FIG. 6A show an Internet packet and a local network packet.

FIG. 6B shows a local network packet masqueraded as the Internet packet.

FIG. 7 is a flowchart of a method enabling an assistant device communicating with appliances using a local network protocol to communicate with a second device outside the local network protocol.

FIG. 8 is a flowchart of a method to provide an adaptable user interface.

FIG. 9 shows a system enabling communication an assistant device and the second device, when the second device is not connected to a local network.

FIG. 10 is a diagrammatic representation of a machine in the example form of a computer system within which a set of instructions, for causing the machine to perform any one or more of the methodologies or modules discussed herein, may be executed.

### DETAILED DESCRIPTION

### Terminology

Brief definitions of terms, abbreviations, and phrases used throughout this application are given below.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not others.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements. The coupling or connection between the elements can be physical, logical, or a combination thereof. For example, two devices may be coupled directly, or via one or more intermediary channels or devices. As another example, devices may be coupled in such a way that information can be passed there between, while not sharing any physical connection with one another. Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

If the specification states a component or feature “may,” “can,” “could,” or “might” be included or have a characteristic, that particular component or feature is not required to be included or have the characteristic.

The term “module” refers broadly to software, hardware, or firmware components (or any combination thereof). Modules are typically functional components that can generate useful data or another output using specified input(s). A module may or may not be self-contained. An application program (also called an “application”) may include one or more modules, or a module may include one or more application programs.

The terminology used in the Detailed Description is intended to be interpreted in its broadest reasonable manner, even though it is being used in conjunction with certain examples. The terms used in this specification generally have their ordinary meanings in the art, within the context of the disclosure, and in the specific context where each term is used. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that the same element can be described in more than one way.

Consequently, alternative language and synonyms may be used for any one or more of the terms discussed herein, but special significance is not to be placed upon whether or not a term is elaborated or discussed herein. A recital of one or more synonyms does not exclude the use of other synonyms. The use of examples anywhere in this specification, including examples of any terms discussed herein, is illustrative only and is not intended to further limit the scope and meaning of the disclosure or of any exemplified term. Likewise, the disclosure is not limited to various embodiments given in this specification.

### Him Remote Control of an Assistant Device Using an Adaptable User Interface

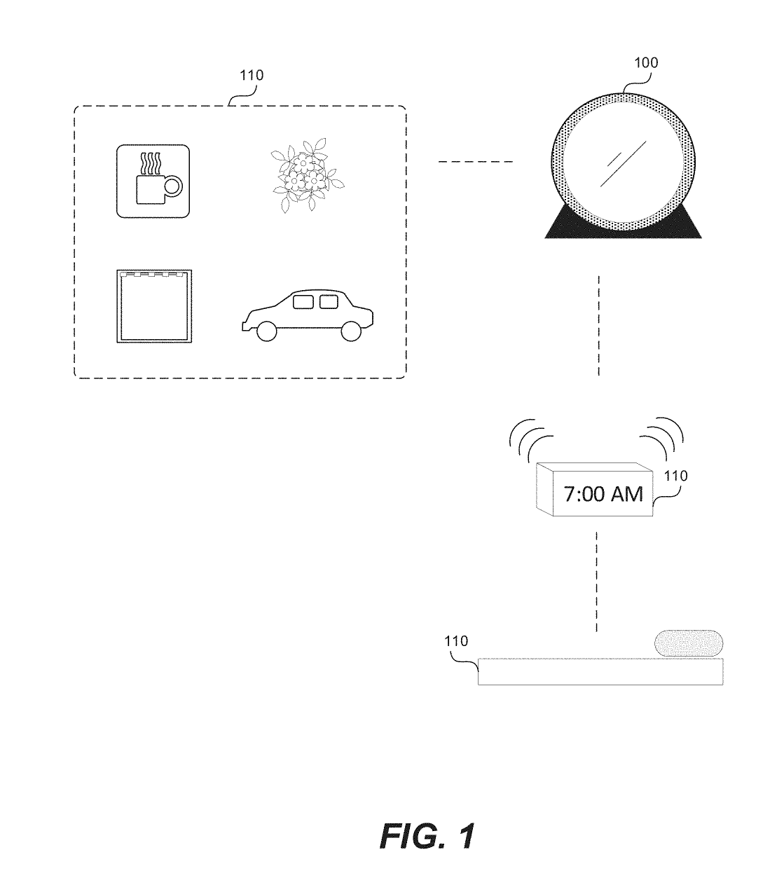

FIG. 1 shows an assistant device interacting with other home devices. The assistant device 100 can be a central hub inside a home for controlling other home devices 110 enabled for communication, such as Internet of things communication. The assistant device 100 can receive an input from a user and in response send commands to the various home devices 110 including a TV, a light, a lock, a coffee maker, sprinklers, etc. The assistant device 100 can interact with the user through an adaptable user interface presented on a display of the assistant device 100.

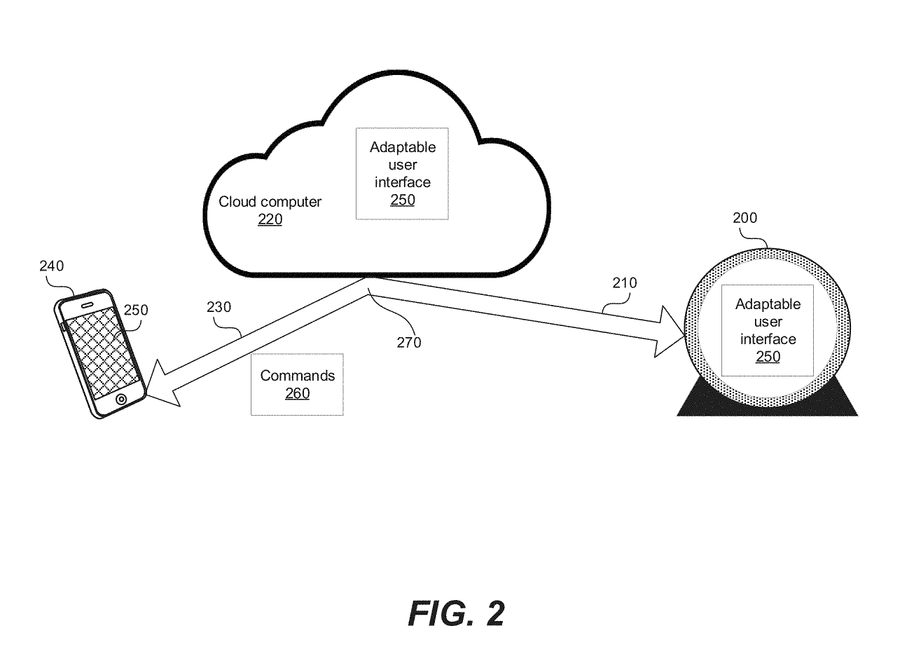

FIG. 2 shows a system enabling the assistant device to interact with a second device associated with the user when the second device and the user are not at home. The system includes the assistant device 200, a cloud computer 220, the second device 240, and the connections 210, 230 forming a tunnel 270. The second device 240 can be a mobile device, a tablet, a watch, glasses, etc., or any kind of device that the user tends to carry with him. The assistant device 200 can be a device such as Alexa, Google home, etc.

When the second device 240, and the assistant device 200 are at home, the second device 240 and the assistant device 200 can interact through a home connection such as a Wi-Fi connection, a local area network connection, etc. The protocol used in communicating between the second device 240 and the assistant device 200 can be an in-home protocol different from the standard Internet protocol such as TCP/IP. During the interaction, the assistant device 200 can also present an adaptable user interface 250 to the user, and receive an input from the user. The adaptable user interface 250 can be an interface built using progressive web application framework, as described further in this application.

The assistant device 200 may not have a cell connection or a data connection, and in some embodiments can only be reached through a network connection 210. Through the network connection 210, the assistant device 200 can communicate with a cloud computer 220. The assistant device 200 can receive updates to the adaptable user interface 250 from the cloud computer 220, and/or the assistant device 200 can send user modifications to the adaptable user interface 250 to the cloud computer 220. The updates can be sent between the assistant device 200 and the cloud computer 220 as the updates became available, or upon request.

To establish a communication between the second device 240 and the assistant device 200, a tunnel 270 including connections 210, 230 can be created, because in certain embodiments, the second device 240 and the assistant device 200 cannot communicate via cell networks or data networks. The cloud computer 220 can provide the adaptable user interface 250 to the second device 240. Having the cloud computer 220 provide the adaptable user interface 250 to the second device, instead of the assistant device 200, saves the communication bandwidth on the connection 210.

The second device 240 can provide the commands 260 controlling the adaptable user interface 250, back to the cloud computer 220, which in turn provides the commands 260 to the assistant device 200. Communicating the commands 260, as opposed to communicating the whole adaptable user interface 250, reduces the usage of the bandwidth across connections 210, 230.

The tunnel 270 including connections 210, 230 is a mechanism used to ship a foreign protocol across a network that normally wouldn't support the foreign protocol. Specifically, the tunnel 270 ships the in-home protocol used to communicate between the assistant device 100 in FIG. 1, and the home devices 110 in FIG. 1 across the Internet using, for example, TCP/IP protocol. The tunnel 270 sends the in-home protocol in the “data” portion of the TCP/IP datagram.

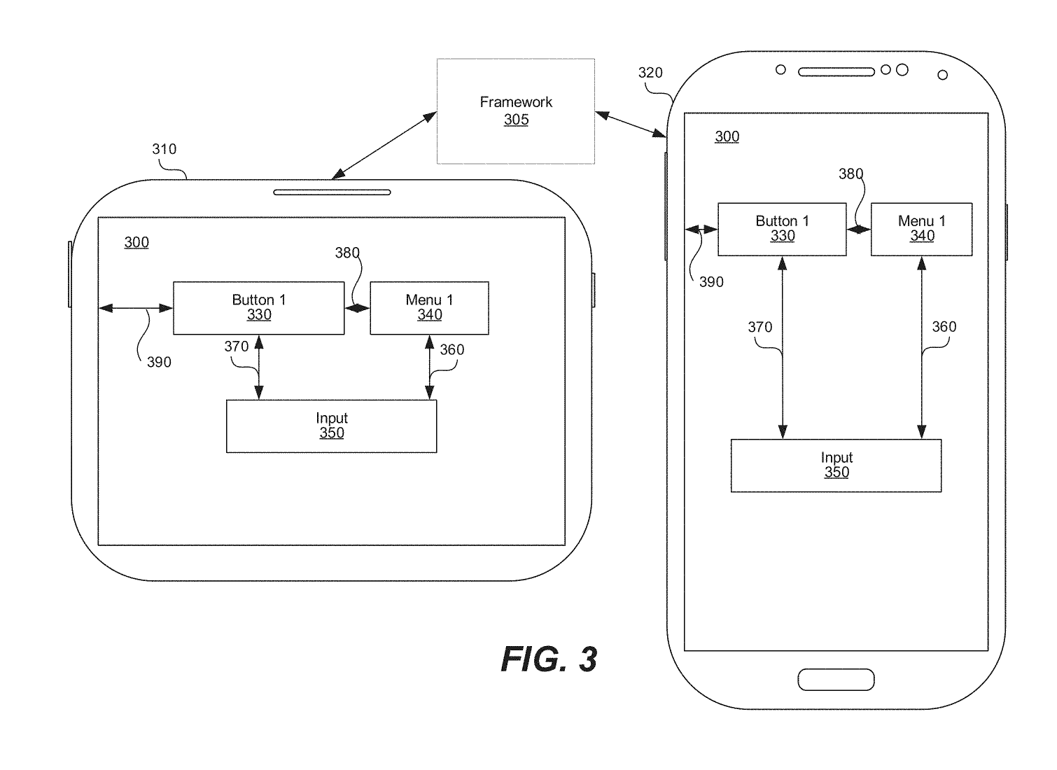

FIG. 3 shows an example of an adaptable user interface. The adaptable user interface 300 can be defined on any device 310, 320, such as a personal computer, a tablet, a laptop, a cell phone, etc. The adaptable user interface 300 can be an interface built using progressive web application framework (“framework”) 305.

The framework 305 allows the developer to specify a layout of the adaptable user interface 300, and the framework 305 automatically adapts the layout of the adaptable user interface 300 to the size of the display. The framework 305 eases the development process because the developer needs to specify the adaptable user interface 300 only once, and the framework 305 automatically adapts the user interface 300 to the device 310, 320 on which the user interface 300 is being displayed. Consequently, development time is saved, and as a result consumption of computer resources such as processing power, memory, and bandwidth because developers do not have to consume the computer resources to iteratively adopt a user interface 300 to various devices 310, 320 on which the user interface 300 is displayed.

A processor implementing the framework 305 (“processor”), can automatically transfer the adaptable user interface 300 to a display of a different device 320, without requiring further input from the developer. The processor implementing the framework 305 can be associated with the cloud computer 220 in FIG. 2. The processor can store: the aspect ratio of a display of the device 310, in which the adaptable user interface 300 is designed; the aspect ratios of various user interface elements 330, 340, 350, the relative distances 360, 370, 380 between the user interface elements 330, 340, 350; and/or the distances 390 (only one labeled for brevity) between the user interface elements 330, 340, 350 and the screen.

Before the adaptable user interface 300 is displayed on the device 320, the processor can obtain the aspect ratio of a display of the device 320. The processor can hierarchically adjust various properties of the adaptable user interface 300, from the most desirable to adjust, to the least desirable to just. The most desirable property to adjust can be the relative distances 360, 370, 380 between the user interface elements 330, 340, 350. The least desirable aspect to adjust can be the aspect ratio of the various user interface elements 330, 340, 350.

For example, based on the difference between the aspect ratio of the device 310 and the aspect ratio of the device 320, initially, the processor can adjust the relative distances 365, 375, 385 between the user interface elements 330, 340, 350. If further adjustment is needed, the processor can adjust the distance 390 (only one labeled for brevity) between the user interface elements 330, 340, 350 and the screen. Lastly, the processor can adjust the aspect ratio of various user interface elements 330, 340, 350. In another embodiment, the distance 390 between the user interface elements 330, 340, 350 and the screen can be one of the most desirable properties to adjust along with the relative distances 360, 370, 380 between the user interface elements 330, 340, 350.

As can be seen in FIG. 3, in the adaptable user interface 300 displayed on the device 320, the distances 360, 370, 380 between the user interface elements 330, 340, 350 have been adjusted. Further, the distance 390 between the user interface elements 330, 340, 350 and the screen has been adjusted. Finally, the aspect ratio of the user interface elements 330, 340 has been adjusted to more closely resemble the aspect ratio of the device 320.

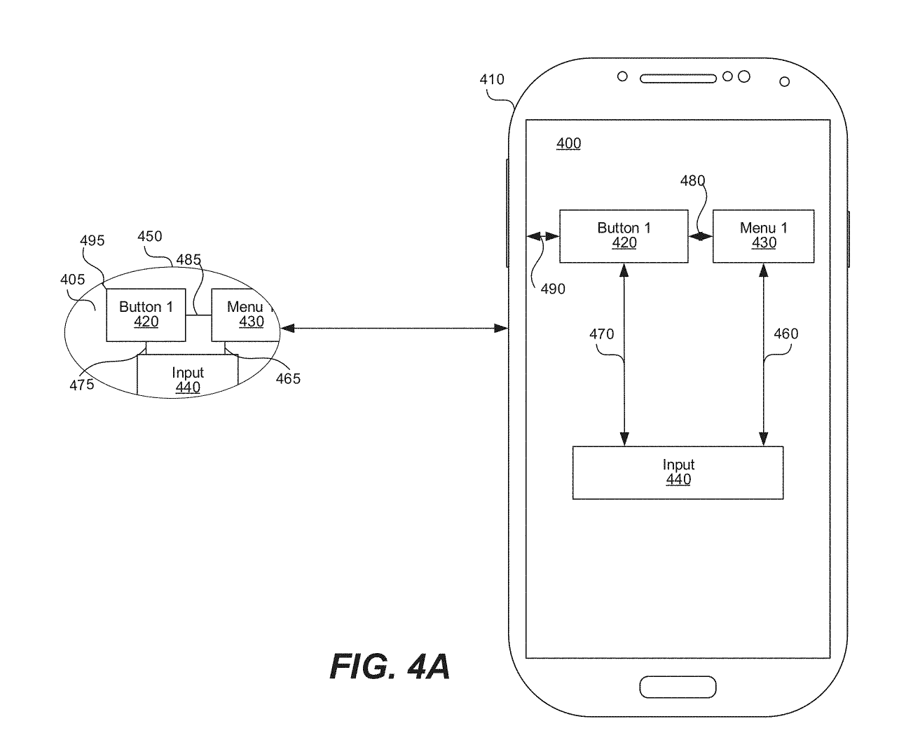

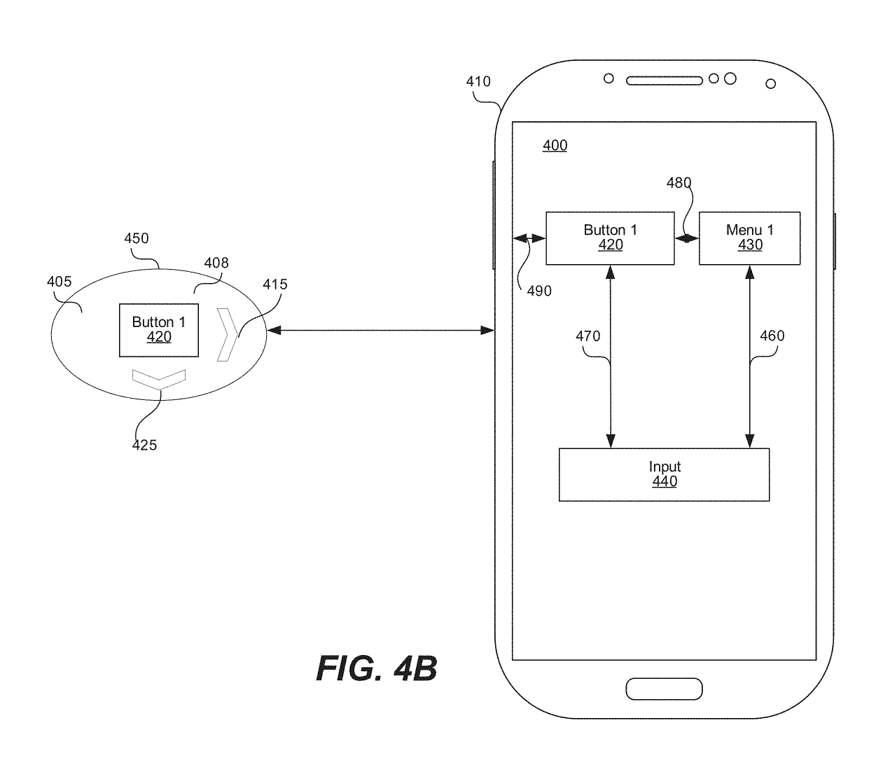

FIGS. 4A-4B show an adaptable user interface on various displays. The adaptable user interface 400 can be defined on a display 410. The adaptable user interface 400 can include various user interface elements such as one or more buttons 420, one or more menus 430, one or more input boxes 440, etc.

Display 450 may need to display the adaptable user interface 400. Display 450 can have different shape and size. Display 450 can be a round display, an elliptical display, circular display, etc. The shape and/or the size of the display 450 can be described using an aspect ratio. For example, when the display 450 is elliptical, the aspect ratio can be specified as the ratio of the major axis to the minor axis.

When the adaptable user interface 400 needs to be displayed on the display 450, a processor associated with the display 450 can automatically adjust a layout 405 of the adaptable user interface 400. To automatically adjust the layout the processor can adjust the location of the user interface elements 420, 430, 440 on the display 450. As can be seen in FIG. 4A, the relative distances 460, 470, 480 between the user interface elements 420, 430, 440 and relative distances 490 (only one labeled for brevity) between the user interface elements 420, 430, 440 and the display 410, have been adjusted, i.e. reduced, to be accommodated on the display 450, as shown in FIG. 4A.

Each user interface element 420, 430, 440 can have a predefined minimum readability requirement, indicating a minimum size of the user interface element 420, 430, 440. The predefined minimum readability requirement specifies a set of criteria regarding the adaptable user interface that should be satisfied before the adaptable user interface can be displayed. The criteria can include size of the user interface elements, distance between the user interface elements, distance between the user interface elements in the screen, text wrapping within the user interface elements, whether a user interface element can be truncated, various display shapes and sizes that are supported, etc.

For example, the predefined minimum readability requirement can take into account the user-specified font size, and the amount of text to display within the user interface element 420, 430, 440 and determine the minimum size of the user interface element 420, 430, 440. In another example, the predefined minimum readability requirement can specify that a single word in the text contained within the user interface element 420, 430, 440 cannot wrap around, that the whole text contained within the user interface element 420, 430, 440 cannot wrap around, etc. The predefined minimum readability requirement can indicate a minimum size associated with a user interface element. In FIG. 4A the predefined minimum readability requirement specifies that the whole text contained within the user interface element 420, 430, 440 cannot wrap around. As a result, the user interface elements 420, 430, 440 shown in the display 450, have reached the predefined minimum readability requirement.

Further, the predefined minimum readability requirement can also indicate a minimum distance between various user interface elements 420, 430, 440. The distances 465, 475, 485 can represent the minimum relative distance between the user interface elements 420, 430, 440. Further, the distance 495 to the screen can be defined to be a minimal distance to the screen, as shown in FIG. 4A. Distance 495 can be the minimum distance satisfying the predefined minimum readability requirement.

Once the predefined minimum readability requirement of the user interface element 420, 430, 440 is reached, as shown in FIG. 4A, the processor can determine if any of the user interface elements 420, 430, 440 have been at least partially truncated. As shown in FIG. 4A, user interface elements 430 and 440 have been partially truncated by the display 450. As a result, the processor can split layout 405 the adaptable user interface 400 into one or more pages, where each page is displayed separately on the display 450.

As shown in FIG. 4B, the truncated user interface elements 430, 440 can be moved to a page separate from the page 408 containing the user interface element 420. The page 408 can contain an indication 415, 425 of the location of the other one or more pages.

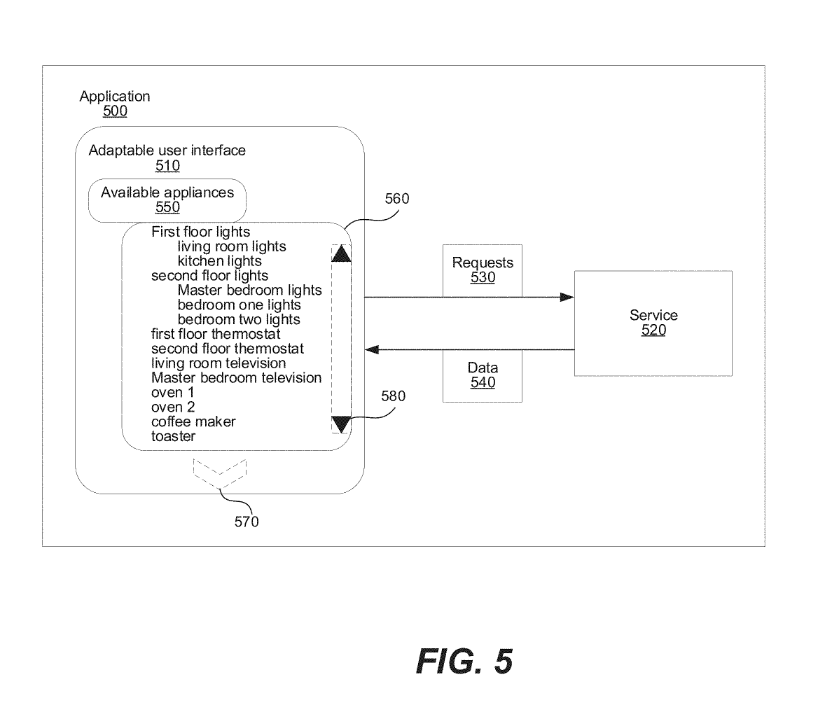

FIG. 5 shows a design of a software application. The software application 500 (“application”), can include two separate parts: an adaptable user interface 510, and a service 520. The adaptable user interface 510 can send a request 530 to the service 520. After performing a computation based on the request 530, the service 520 can send data 540 back to the adaptable user interface 510. To be able to perform the functions described in this application, the software user interface should be designed initially in at least two separate parts, the adaptable user interface 510 and the service 520.

The adaptable user interface 510 can be implemented using hypertext markup language (HTML). A processor associated with a device not enabled with a web browser, and/or not connected to the Internet, can be enabled to run the adaptable user interface. The device can be the assistant device 200 in FIG. 2.

The adaptable user interface 510 can have user interface elements 550, 560. User interface element 550 can be a selectable button, or an un-selectable text. The user interface element 550 can be static with a predefined text to display. The user interface element 560 can have a variable size, which changes depending on the data 540 provided by the service 520 part of the application 500.

For example, when the user interface element 550 is a selectable button, and is activated by a user, the adaptable user interface 510 can send the request 530 to the service 520 asking for a list of available appliances to the assistant device 200 in FIG. 2. The data 540 sent back can contain a list of the available appliances. The list can have a variable length, depending on the number of appliances available to the assistant device 200. Consequently, the user interface element 560 can have varying size.

The adaptable user interface 510 can adjust a layout based on a size of the user interface element 560. For example, a processor associated with the adaptable user interface 510 can determine that fitting the user interface element 550, 560 within one page does not satisfy the predefined minimum readability requirement and/or that at least one of the user interface elements 550, 560 is partially truncated. Consequently, the processor can separate the user interface elements 550, 560 into separate pages, or can separate a single user interface element into separate pages, such as user interface element 560 in FIG. 5. The processor separates the user interface elements 550, 562 separate pages, the processor can provide an indicator 570 that additional pages are available in the adaptable user interface 510.

The predefined minimum readability requirement can indicate which user interface element can be split into multiple pages, or can indicate that the variable size user interface elements, such as user interface element 560, can be split into multiple pages. As shown in FIG. 5, the user interface element 560 is split into multiple pages, and an indicator 580 shows that additional pages are available.

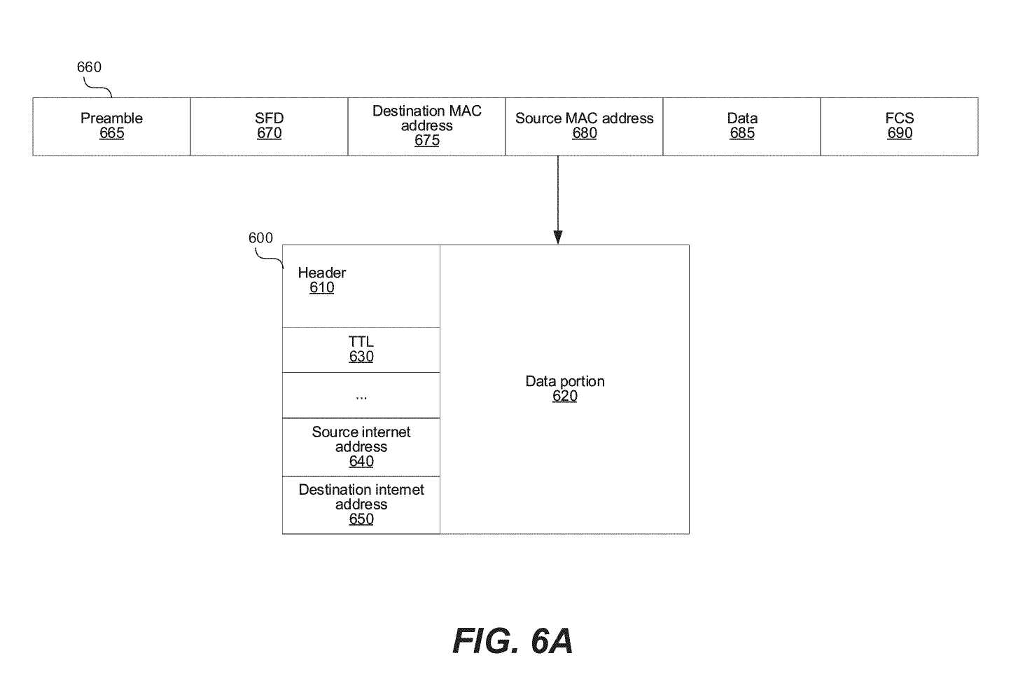

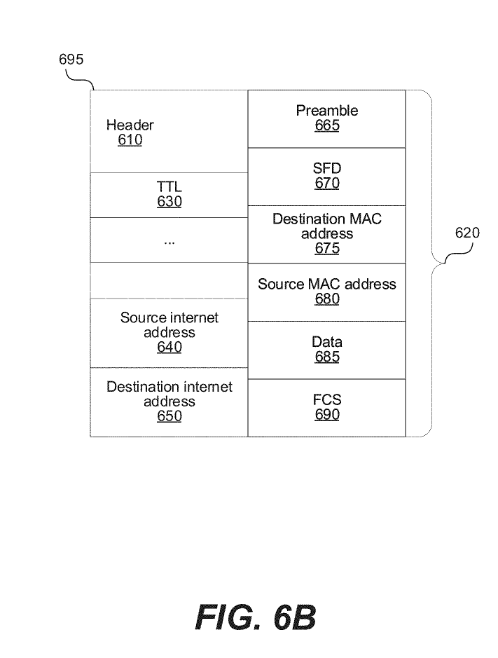

FIG. 6A show an Internet packet and a local network packet. The Internet packet 600 contains a header portion 610 and a data portion 620. The data portion 620 contains the payload of the Internet packet 600, i.e. the part of transmitted data that is the actual intended message.

Header portion 610 can contain multiple sections, some of which are shown in FIG. 6A. The header portion 610 can contain:
1. 4 bits that contain the version, that specifies if it's an IPv4 or IPv6 packet,
2. 4 bits that contain the Internet Header Length, which is the length of the header in multiples of 4 bytes (e.g., 5 means 20 bytes).
3. 8 bits that contain the Type of Service, also referred to as Quality of Service (QoS), which describes what priority the packet should have,
4. 16 bits that contain the length of the packet in bytes,
5. 16 bits that contain an identification tag to help reconstruct the packet from several fragments,
6. 3 bits. The first contains a zero, followed by a flag that says whether the packet is allowed to be fragmented or not (DF: Don't fragment), and a flag to state whether more fragments of a packet follow (MF: More Fragments)
7. 13 bits that contain the fragment offset, a field to identify position of fragment within original packet
8. 8 bits that contain the Time to live (TTL) 630, which is the number of hops (router, computer or device along a network) the packet is allowed to pass before it dies (for example, a packet with a TTL of 16 will be allowed to go across 16 routers to get to its destination before it is discarded),
9. 8 bits that contain the protocol (TCP, UDP, ICMP, etc.)
10. 16 bits that contain the Header Checksum, a number used in error detection,
11. 32 bits that contain the source Internet protocol (IP) address, 640,
12. 32 bits that contain the destination Internet protocol (IP) address, 650.

Using the header 610, the Internet packet 600 can be routed through the Internet to the destination IP address 650.

The local network packet 660 can include a preamble 665, start frame delimiters (SFD) 670, destination media access control (MAC) address 675, source MAC address 680, data portion 685, i.e. payload, and frame check sequence (FCS) 690. The preamble 665 includes a 56-bit (seven-byte) pattern of alternating 1 and 0 bits, allowing devices on the network to easily synchronize their receiver clocks, providing bit-level synchronization. SFD 670 can mark the end of the preamble 665. The SFD 670 is designed to break the bit pattern of the preamble and signal the start of the actual frame.

The SFD 670 is the eight-bit (one-byte) value that marks the end of the preamble, which is the first field of an Ethernet packet, and indicates the beginning of the Ethernet frame. The SFD 670 is immediately followed by the destination MAC address, which is the first field in an Ethernet frame. MAC address of a device is a unique identifier assigned to the device. MAC addresses are most often assigned by the manufacturer of a network interface controller (NIC) and are stored in its hardware, such as the card's read-only memory or some other firmware mechanism. The destination MAC address 675 and the source MAC address 680 contain the MAC address of the destination device and the source device, respectively. In contrast to the Internet packet 600, which contains Internet protocol addresses, the local network packet 660 contains MAC addresses, which can be physical addresses of the source and destination devices.

The payload 685 carries the message of the data packet such as “activate the thermostat.” The size of the payload 685 varies between 42 octets when an and 1500 octets. When the actual payload is less, padding bytes are added accordingly. Non-standard jumbo frames allow for larger maximum payload size.

The frame check sequence (FCS) 690 is a four-octet cyclic redundancy check (CRC) that allows detection of corrupted data within the entire frame as received on the receiver side. The FCS value is computed as a function of the protected MAC frame fields: source and destination address, length/type field, MAC client data and padding (that is, all fields except the FCS).

Running the CRC algorithm over the received frame data including the CRC code will always result in a zero value for error-free received data, because the CRC is a remainder of the data divided by the polynomial. However, this technique can result in “false negatives”, in which data with trailing zeroes will also result in the same zero remainder. To avoid this scenario, the FCS is complemented (reversed for each bit) by the sender before it is attached to the end of the payload data. This way, the algorithm result will always be a magic number or CRC32 residue of 0xC704DD7B when data has been received correctly. This allows for receiving a frame and validating the FCS without knowing where the FCS field actually starts.

When masqueraded, the local network packet 660 is inserted into the data portion 620 of the Internet packet 600.

FIG. 6B shows a local network packet masqueraded as the Internet packet. As seen in FIG. 6A the Internet packet 600 and the local network packet 660 have different components. When masqueraded, the whole local network packet 660 can be inserted into the payload portion 620 of the Internet packet 600, to produce an Internet packet 695. Using the header 610 of the Internet packet 600, the local network packet 660 can be transmitted through the Internet to the destination IP address 650, which can be a user's device such as a cell phone, a tablet, personal digital assistant, etc., when the second device 240 in FIG. 2 is out of the reach of the local network.

Once the second device 240 receives the Internet packet 695, the second device 240 can analyze the payload portion 620 to determine a message sent from the assistant device, such as device 200 in FIG. 2. Similarly, the second device 240 can send a masqueraded local network packet to the assistant device 200.

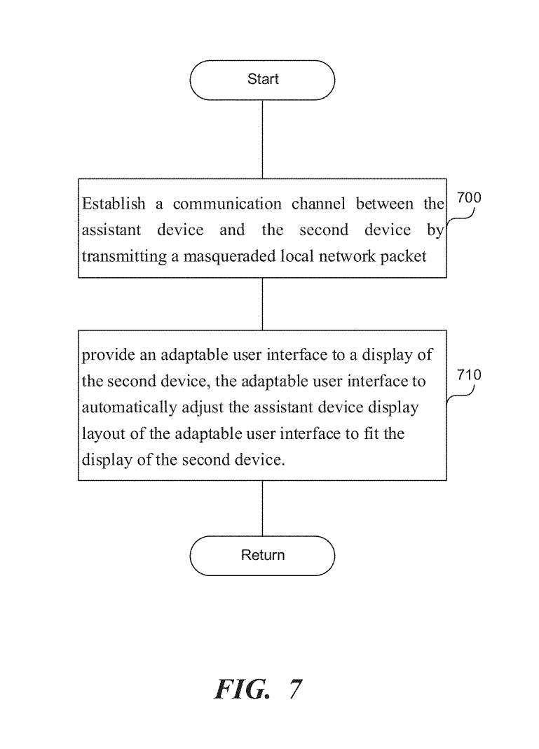

FIG. 7 is a flowchart of a method enabling an assistant device communicating with appliances using a local network protocol to communicate with a second device outside the local network protocol. In step 700, a processor can establish a communication channel between the assistant device and the second device by transmitting a masqueraded local network packet as an Internet packet. The local network packet can be formatted according to the local network protocol used to communicate between the assistant device and the appliances. The Internet packet can be formatted according to an Internet protocol used to communicate between Internet connected devices as shown in FIGS. 6A-6B.

The Internet protocol can be TCP/IP. The local network protocol can be infrared, Wi-Fi, Z-wave, Bluetooth, Zig-Bee, WeMo, Nest, Thread, X10, Universal Power Line Bus, Insteon, Ethernet, etc.

In step 710, the processor can provide an adaptable user interface to a display of the second device. A second device display layout of the adaptable user interface can be substantially identical to an assistant device display layout of the adaptable user interface, as described in this application in FIGS. 3-4B. The substantially identical user interface can at least satisfy the predetermined minimum readability requirements as described in this application. The adaptable user interface can automatically adjust the assistant device display layout of the adaptable user interface to fit the display of the second device.

The adaptable user interface can be a webpage in HTML. The adaptable user interface can include multiple user interface elements and multiple positions associated with the user interface elements.

The processor can receive an indication of size of the assistant device display and an indication of size of the second device display. The processor can determine a ratio between the indication of size of the second device display and the indication of size of the assistant device display. Based on the ratio the processor can adjust the positions associated with the user interface elements displayed on the second device display. For example, to adjust the distances, the processor can multiply the distances by the ratio. Also, the processor can adjust the distances between the elements and the screen based on the ratio, as described in FIG. 4A. Specifically, the processor can multiply the distances to the screen by the ratio of indication of size of the second device display and the indication of size of the assistant device display. The indication of size can include an aspect ratio of a display.

The processor can reduce Internet bandwidth consumption by providing the adaptable user interface to the second device 240 in FIG. 2 from a processor establishing the communication channel, such as the cloud computer 220 in FIG. 2, instead of requiring the adaptable user interface to be sent from the assistant device 200. To do this, the processor can store a first copy of the adaptable user interface in a memory associated with a processor establishing a first communication channel between the processor and the assistant device and a second communication channel between the processor and the second device. A second copy of the adaptable user interface can be stored in a second memory associated with the assistant device.

The processor can reduce the Internet bandwidth consumption by serving the first copy of the adaptable user interface to the second device without requesting the second copy of adaptable user interface from the assistant device. Aside from the adaptable user interface, the communication between the second device in the assistant device are tunneled in both directions through the processor establishing the communication channel, such as the cloud computer 220.

To be able to reduce the Internet bandwidth consumption, the first copy in the second copy of the adaptable user interface should be identical. To ensure that the first copy and the second copy of the adaptable user interface match, the processor can send updates to first and/or second copy between the two copies. For example, the assistant device can receive modification to the second copy of the adaptable user interface from the user. Such as, specifying font size, configuring user interface elements, redefining the initiation screen, etc. The assistant device can send the updates to the processor establishing the communication. The processor establishing a communication can reduce Internet bandwidth consumption by modifying the first copy of the adaptable user interface according to the change prior to serving the first copy of the adaptable user interface to the second device.

The processor can transmit a masqueraded local network packet between the second device and the assistant device. The processor can receive the Internet packet including a header portion storing an Internet address associated with the second device, and a data portion storing the masqueraded local network packet formatted according to the local network protocol used to communicate between the assistant device and the appliances. The processor can forward the Internet packet to the second device without analyzing the data portion. But not analyzing the data portion of the Internet packet, privacy of the communication, and ultimately privacy of the user is preserved. Further, the forwarding is efficient because the analysis of the data portion of the packet is avoided.

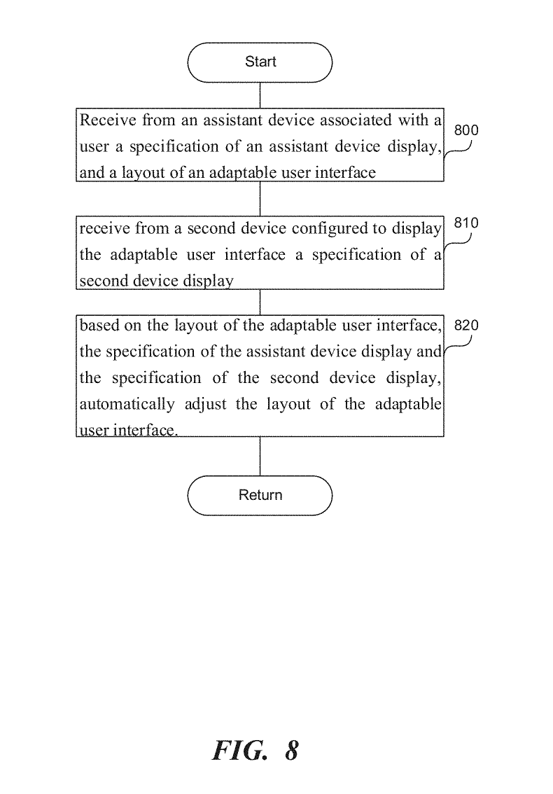

FIG. 8 is a flowchart of a method to provide an adaptable user interface. In step 800, processor can receive from an assistant device a specification of an assistant device display, and a layout of an adaptable user interface including user interface elements and locations associated with the user interface elements. The user interface elements include buttons, text fields, menus, tabs etc. The layout of the adaptable user interface can include sizes associated with the user elements, and locations of the user interface elements. In step 810, the processor can receive from a second device configured to display the adaptable user interface a specification of a second device display. The specification of the second device display can be make and model of the device, or an indication of size such as aspect ratio of the display, or dimensions of the display.

In step 820, based on the layout of the adaptable user interface, the specification of the assistant device display and the specification of the second device display, the processor can automatically adjust the layout of the adaptable user interface to present on the second device display without partially truncating a user interface element in the user interface elements.

In one embodiment, to automatically adjust the layout, the processor can determine a ratio between the indication of size of the assistant device display and the indication of size of the second device display. For example, the ratio can be obtained by dividing the aspect ratio of the second device by the aspect ratio of the assistant display device. Based on the ratio the processor can adjust distances between the user interface elements displayed on the second device display. For example, the processor can multiply the distances by the calculated ratio. Also, the processor can multiply the distances between the user interface elements and the screen by the ratio, to obtain the new set of distances.

In another embodiment, to automatically adjust the layout, the processor can define hierarchy of adjustments to fit display, according to preference. Based on the locations associated with the user interface elements within the assistant device display, the processor can obtain a first group of distances between the user interface elements, and a second group of distances between the user interface elements and the assistant device display. The processor can order properties of the layout of the adaptable user interface, such as various distances, from most desirable to adjust to least desirable to adjust. There can be multiple properties at the same level of desirability to adjust. For example, distances among the various user interface elements and distances between the various user and the display can be ranked as the most desirable to adjust, followed by sizes of the various user interface elements. The processor can adjust the most desirable properties prior to adjusting the least desirable properties.

In a third embodiment, to automatically adjust the layout, the processor can split the adaptable user interface into multiple pages, and can provide an indicator that the additional pages are available, as described in FIGS. 4B, 5. The processor can determine that the second device display cannot present the adaptable user interface above a predefined minimum readability requirement. The predefined minimum readability requirement, as described in this application can include an indication of a minimum distance between two or more user interface elements, or a minimum user interface element size.

The processor can separate the adaptable user interface into a first page and a second page, so that the first page and the second page satisfy a predefined minimum readability requirement. The processor can present the first page on the second device display along with an indication of an existence of the second page.

A user interface element can have variable size because, for example, the user interface element is dynamically computed, as described in FIG. 5. The processor can receive the user interface element having a changed size. The processor can determine that the layout of the adaptable user interface including the changed size of the user interface element at least partially truncates one or more user interface elements in the user interface elements. The processor can separate the adaptable user interface into a first page and a second page, where the first page and the second page satisfy the predefined minimum readability requirement. The processor can present the first page on the second device display along with an indication of an existence of the second page, as shown in FIGS. 4B and 5.

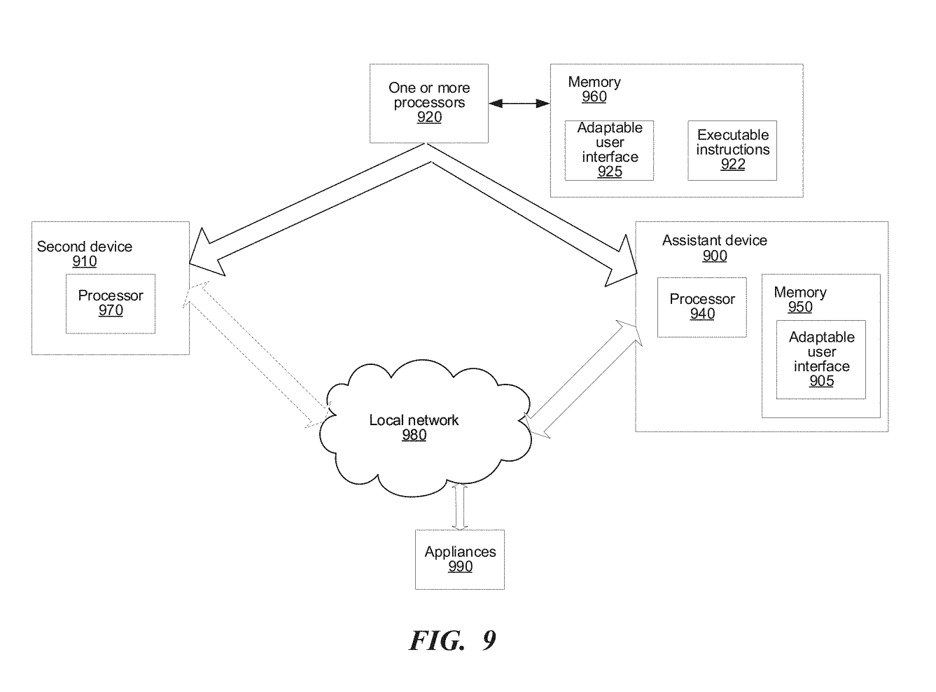

FIG. 9 shows a system enabling communication an assistant device and the second device, when the second device is not connected to a local network. The system includes the assistant device 900, the second device 910, one or more processors 920, the communication channel 930, local network 980, and appliances 990. The communication channel 930 is an Internet communication channel and can be used to carry Internet protocol network packets between the second device 910 and the assistant device 900. The assistant device 900 can communicate with the appliances 990 using a local network protocol associated with the local network 980.

The second device 910 can be configured to communicate using an Internet protocol and to communicate with the assistant device using the local network protocol when the second device is connected to the local network 980 associated with the local network protocol. As described in this application, the second device can be a personal digital assistant, cell phone, a tablet, a watch, smart glasses, etc.

The processor 920 can be associated with a cloud computer. The processor 920 can receive a request to create a communication channel between the assistant device 900 and the second device 910. The request can be from either the assistant device 900 or the second device 910. Upon receiving the request, the processor 920 can create the communication channel by receiving a network packet formatted according to an Internet protocol used to communicate between Internet connected devices. The Internet packet can include a local network packet formatted according to the local network protocol. The processor 920 can forward the network packet without analyzing the local network packet. By avoiding analysis of the local network packet, the user privacy is increased, because information associated with the user is not analyzed by the processor 920 which can be a cloud computer. Further, processing efficiency is increased, because no analysis is performed.

In another embodiment, the assistant device 900, or the second device 910 can ask the user for permission to analyze the local network packet received by the processor 920. If the user grants permission, the processor 920 can learn from the received user data included in the local network packet. For example, the processor 920 can learn the user's habits, increase the accuracy of speech recognition, etc.

The assistant device 900 can have a processor 940. The processor 940 can be configured by executable instructions to encrypt the local network packet prior to sending the local network packet to the one or more processors. The encryption is a further guarantee that the processor 920 cannot access the contents of the local network packet.

The assistant device 900 can have a first memory 950 storing an adaptable user interface 905. A second memory 960 associated with processor 920 can store copy of the adaptable user interface 925 and executable instructions 922 to reduce Internet bandwidth consumption between the processor 920 and the assistant device 900. The executable instructions 922 can cause the processor 920 to serve the copy of the adaptable user interface 925 to the second device 910 without consuming the Internet bandwidth by requesting the adaptable user interface from the assistant device consuming bandwidth of channel between the processor 920 and the assistant device 900.

The processor 940 associated with the assistant device 900 can receive a change to the adaptable user interface from a user. For example, the user can update the layout of the adaptable user interface 905, the initial page associated with the adaptable user interface 905, etc. To ensure that the copy of the adaptable user interface 925 is synchronized with the adaptable user interface 905, the processor 940 can propagate the change to the processor 920, thereby reducing Internet bandwidth consumption between the processor 920 and the assistant device 900 by avoiding repeatedly requesting the adaptable user interface 905 from the assistant device 900.

The second device 910 can have a processor 970 which can receive a request from a user to create the communication channel 930. The processor 970 can request from the user to select the assistant device from multiple assistant devices associated with the second device 910. For example, the second device 910 can be used to control multiple assistant devices in a single location, or multiple locations. Further, the processor 970 can receive selections for multiple assistant devices, and create channel 930 controlling multiple assistant devices. Upon receiving a selection from the user, sending the request to the one or more processors to create the communication channel between the assistant device and the second device.

The processor 940 can determine that the second device 910 is not connected to the local network 980. For example, the processor 940 can make the determination by sending a local network packet to the second device 910, and receiving notification that the packet could not be delivered because the second device 910 is not available on the local network 980. The local network packet can be a test packet without a meaningful payload, or the local network packet can request a permission from the second device 910 to send a communication and/or a control to an appliance. Before or after sending the local network packet to the second device 910, the processor 940 can determine a communication to send to an appliance. Upon determining that the second device 910 is not available on the local network 980, the processor 940 can send the request to establish the communication channel 930 between the assistant device 900 and the second device 910.

For example, the communication to be sent to the appliance can be determined in response to determining that the second device 910 is not available in the user network. For example, the processor 940 can determine that the second device 910 is not available on the local network 980, and that the stove is turned on. As a result, the processor 940 can request a creation of the communication channel 930 to ask a permission from the second user device 910 to turn off the stove. The processor can periodically send local network packet to the second device 910 to determine the weather the second device 910 is available the local network 980, and decide whether an action is to be taken.

In another example, the communication sent to the appliance may not be dependent on the availability of the second device 910 on the local network 980. Independently of the presence of the second device 910 on the local network 980, the processor 940 can determine the communication to send to the appliance, and send a request to the second device 910 to approve the communication. Once the processor 940 receives notification that the second device 910 is not available in the local network 980, the processor can request a creation of the communication channel 930.

The processor 940 can receive the local network packet formatted according to the local network protocol used to communicate between the assistant device and the appliances 990. The processor 940 can masquerade the local network packet into an Internet packet formatted according to an Internet protocol by storing the local network packet into a data portion of the Internet packet, and storing an Internet address associated with the second device in a header portion of the Internet packet.

The processor 940 and/or the processor 970 can adjust the adaptable user interface to fit the display of the assistant device 900 and/or second device 910, respectively. The adjustment can involve separating the adaptable user interface into multiple pages. The processor 940, 970 can determine that the assistant device display cannot present the adaptable user interface above a predefined minimum readability requirement, as described in this application. The processor 940, 970 can separate the adaptable user interface into a first page and a second page, where the first page and the second page satisfy a predefined minimum readability requirement. The processor 940, 970 can present the first page on the second device display along with an indication of an existence of the second page.

The processor 940, 970 can dynamically adjust the adaptable user interface based on a varying size of a user interface element. The processor 940, 970 can receive a user interface element having a changed size. For example, the user interface element can be dynamically computed, and can have varying size. The processor 940, 970 can determine that the layout of the adaptable user interface including the changed size of the user interface element at least partially truncates one or more user interface elements in the user interface elements. The processor 940, 970 can separate the adaptable user interface into a first page and a second page, wherein the first page and the second page satisfy the predefined minimum readability requirement. The processor 940, 970 can present the first page on the second device display along with an indication of an existence of the second page.

### Computer

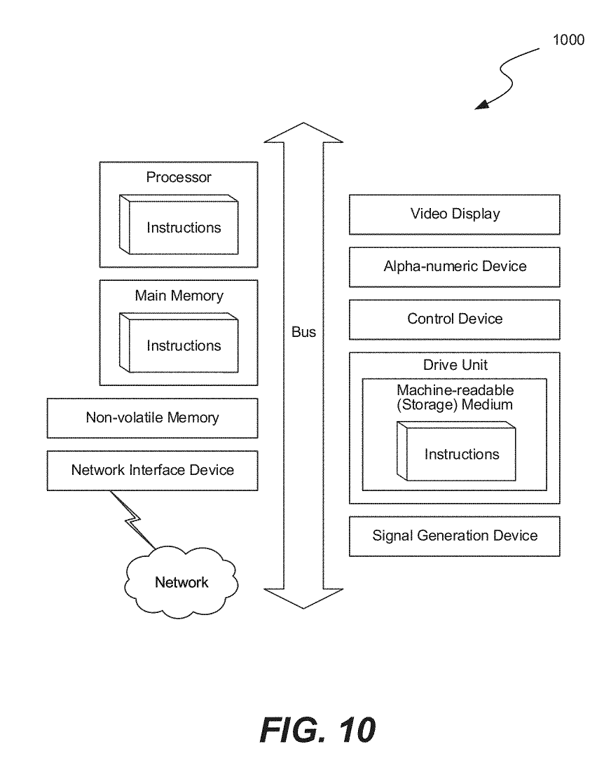

FIG. 10 is a diagrammatic representation of a machine in the example form of a computer system 1000 within which a set of instructions, for causing the machine to perform any one or more of the methodologies or modules discussed herein, may be executed.

In the example of FIG. 10, the computer system 1000 includes a processor, memory, non-volatile memory, and an interface device. Various common components (e.g., cache memory) are omitted for illustrative simplicity. The computer system 1000 is intended to illustrate a hardware device on which any of the components described in the example of FIGS. 1-9 (and any other components described in this specification) can be implemented. The computer system 1000 can be of any applicable known or convenient type. The components of the computer system 1000 can be coupled together via a bus or through some other known or convenient device.

This disclosure contemplates the computer system 1000 taking any suitable physical form. As example and not by way of limitation, computer system 1000 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 1000 may include one or more computer systems 1000; be unitary or distributed; span multiple locations; span multiple machines; or reside in a cloud, which may include one or more cloud components in one or more networks. Where appropriate, one or more computer systems 1000 may perform without substantial spatial or temporal limitation one or more steps of one or more methods described or illustrated herein. As an example and not by way of limitation, one or more computer systems 1000 may perform in real time or in batch mode one or more steps of one or more methods described or illustrated herein. One or more computer systems 1000 may perform at different times or at different locations one or more steps of one or more methods described or illustrated herein, where appropriate.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer 1000. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, storing and entire large program in memory may not even be possible. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system 1000. The interface can include an analog modem, ISDN modem, cable modem, token ring interface, satellite transmission interface (e.g. “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 10 reside in the interface.

In operation, the computer system 1000 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies or modules of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

### REMARKS

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling others skilled in the relevant art to understand the claimed subject matter, the various embodiments, and the various modifications that are suited to the particular uses contemplated.

While embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Although the above Detailed Description describes certain embodiments and the best mode contemplated, no matter how detailed the above appears in text, the embodiments can be practiced in many ways. Details of the systems and methods may vary considerably in their implementation details, while still being encompassed by the specification. As noted above, particular terminology used when describing certain features or aspects of various embodiments should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless those terms are explicitly defined herein. Accordingly, the actual scope of the invention encompasses not only the disclosed embodiments, but also all equivalent ways of practicing or implementing the embodiments under the claims.

The language used in the specification has been principally selected for readability and instructional purposes, and it may not have been selected to delineate or circumscribe the inventive subject matter. It is therefore intended that the scope of the invention be limited not by this Detailed Description, but rather by any claims that issue on an application based hereon. Accordingly, the disclosure of various embodiments is intended to be illustrative, but not limiting, of the scope of the embodiments, which is set forth in the following claims.

1. A system enabling an assistant device communicating with a plurality of appliances using a local network protocol to communicate with a second device outside the local network protocol, the system comprising:
the assistant device communicating with the plurality of appliances using the local network protocol;
the second device configured to communicate using an Internet protocol and to communicate with the assistant device using the local network protocol when the second device is connected to a local network associated with the local network protocol, the second device configured by first executable instructions to:
determine that a second device display cannot present an adaptable user interface above a predefined minimum readability requirement defining a set of criteria regarding the adaptable user interface that must be satisfied before the adaptable user interface can be displayed;
separate the adaptable user interface into a first page and a second page, wherein the first page and the second page satisfy the predefined minimum readability requirement;
present the first page on a second device display along with an indication of an existence of the second page;
one or more processors configured by second executable instructions to communicate with the assistant device and the second device, the second executable instructions comprising instructions to:
receive a request to create a communication channel between the assistant device and the second device;
upon receiving the request, create the communication channel by receiving an Internet packet formatted according to the Internet protocol used to communicate between Internet connected devices, the Internet packet comprising a local network packet formatted according to the local network protocol; and
forward the Internet packet without analyzing the local network packet.

2. A method comprising:
establishing a communication channel between an assistant device and a second device by transmitting a masqueraded local network packet formatted according to a local network protocol used to communicate between the assistant device and a plurality of appliances as an Internet packet formatted according to an Internet protocol used to communicate between a plurality of Internet connected devices; and
providing an adaptable user interface to a display of the second device with a second device display layout of the adaptable user interface substantially identical to an assistant device display layout of the adaptable user interface, the adaptable user interface to automatically adjust the assistant device display layout of the adaptable user interface to fit the display of the second device.

3. The method of claim 2, where the adaptable user interface comprises a plurality of user interface elements and a plurality of positions associated with the plurality of user interface elements; said providing the adaptable user interface comprising:
receiving an indication of size of an assistant device display and an indication of size of a second device display;
determining a ratio between the indication of size of the assistant device display and the indication of size of the second device display; and
based on the ratio adjusting the plurality of positions associated with the plurality of user interface elements displayed on the second device display.

4. The method of claim 3, the indication of size of the assistant device display comprising an aspect ratio of the assistant device display, and the indication of size of the second device display comprising an aspect ratio of the indication of size of the assistant device display comprising an aspect ratio of the assistant device display.

5. The method of claim 2, comprising:
storing a first copy of the adaptable user interface in a memory associated with a processor establishing a first communication channel between the processor and the assistant device and a second communication channel between the processor and the second device, wherein a second copy of the adaptable user interface is stored in a second memory associated with the assistant device; and
reducing Internet bandwidth consumption of the first communication channel by serving the first copy of the adaptable user interface to the second device without requesting the second copy of the adaptable user interface from the assistant device.

6. The method of claim 5, comprising:
ensuring that the first copy of adaptable user interface matches the second copy of the adaptable user interface by receiving a change to the first copy of the adaptable user interface from the assistant device;
reducing Internet bandwidth consumption between the processor and the assistant device by modifying the first copy of the adaptable user interface according to the change prior to serving the first copy of the adaptable user interface to the second device.

7. The method of claim 2, said transmitting the masqueraded local network packet comprising:
receiving the Internet packet comprising a header portion storing an Internet address associated with the second device, and a data portion storing the masqueraded local network packet formatted according to the local network protocol used to communicate between the assistant device and the plurality of appliances; and
forwarding the Internet packet to the second device without analyzing the data portion.

8. A method comprising:
receiving from an assistant device associated with a user a specification of an assistant device display, and a layout of an adaptable user interface comprising a plurality of user interface elements and a plurality of locations associated with the plurality of user interface elements within the assistant device display;
receiving from a second device configured to display the adaptable user interface a specification of a second device display; and
based on the layout of the adaptable user interface, the specification of the assistant device display and the specification of the second device display, automatically adjusting the layout of the adaptable user interface to present on the second device display without partially truncating a user interface element in the plurality of user interface elements.

9. The method of claim 8, wherein the specification of the assistant device display comprises an indication of size of the assistant device display, and the specification of the second device display comprises an indication of size of the second device display; and wherein said automatically adjusting the layout comprises:
determining a ratio between the indication of size of the assistant device display and the indication of size of the second device display; and
based on the ratio adjusting a plurality of distances between the plurality of user interface elements displayed on the second device display.

10. The method of claim 8, said automatically adjusting the layout comprising:
obtaining a plurality of properties of the layout of the adaptable user interface comprising a plurality of sizes associated with the plurality of user interface elements, and a plurality of distances among the user interface elements and a display;
ordering the plurality of properties of the layout of the adaptable user interface from most desirable to adjust to least desirable to adjust; and
adjusting a most desirable property prior to adjusting a least desirable property.

11. The method of claim 8, said automatically adjusting the layout comprising:
determining that the second device display cannot present the adaptable user interface above a predefined minimum readability requirement comprising an indication of a minimum distance between two or more user interface elements;
separating the adaptable user interface into a first page and a second page, wherein the first page and the second page satisfy the predefined minimum readability requirement; and
presenting the first page on the second device display along with an indication of an existence of the second page.

12. The method of claim 8, said automatically adjusting the layout comprising:
receiving a second user interface element in the plurality of user interface elements having a changed size;
determining that the layout of the adaptable user interface including the changed size of the user interface element at least partially truncates one or more user interface elements in the plurality of user interface elements;
separating the adaptable user interface into a first page and a second page, wherein the first page and the second page satisfy a predefined minimum readability requirement; and
presenting the first page on the second device display along with an indication of an existence of the second page.

13. A system comprising:
an assistant device communicating with a plurality of appliances using a local network protocol;
a second device configured to communicate using an Internet protocol and to communicate with the assistant device using the local network protocol when the second device is connected to a local network associated with the local network protocol;
one or more processors configured by executable instructions to communicate with the assistant device and the second device, the executable instructions comprising instructions to:
receive a request to create a communication channel between the assistant device and the second device;
upon receiving the request, create the communication channel by receiving an Internet packet formatted according to the Internet protocol used to communicate between Internet connected devices, the Internet packet comprising a local network packet formatted according to the local network protocol; and
forward the Internet packet without analyzing the local network packet.

14. The system of claim 13, comprising a processor associated with the assistant device configured by second executable instructions to encrypt the local network packet prior to sending the local network packet to the one or more processors.

15. The system of claim 13, comprising:
a first memory associated with the assistant device storing an adaptable user interface;
a second memory associated with the one or more processors storing a copy of the adaptable user interface; and
the executable instructions to reduce Internet bandwidth consumption between the one or more processors and the assistant device, the executable instructions comprising the instructions to:
serve the copy of the adaptable user interface to the second device without consuming the Internet bandwidth by requesting the adaptable user interface from the assistant device.

16. The system of claim 15, comprising a processor associated with the assistant device, the processor configured by second executable instructions to:
receive a change to the adaptable user interface from a user; and
propagate the change to the one or more processors to ensure that the copy of the adaptable user interface and the adaptable user interface are substantially identical thereby reducing Internet bandwidth consumption between the one or more processors and the assistant device by avoiding repeatedly requesting the adaptable user interface from the assistant device.

17. The system of claim 13, comprising a processor associated with the second device, the processor configured by third executable instructions to:
receive the request to create the communication channel;
request a selection of the assistant device from a plurality of assistant devices associated with the second device; and
upon receiving the selection, sending the request to the one or more processors to create the communication channel between the assistant device and the second device.

18. The system of claim 13, comprising a processor associated with the assistant device configured by second executable instructions to:
determine a communication to send to an appliance in the plurality of appliances;
determine that the second device is not connected to the local network; and
upon determining that the second device is not connected to the local network, send the request to establish the communication channel between the assistant device and the second device.

19. The system of claim 13, comprising a processor associated with the assistant device configured by second executable instructions to:
receive the local network packet; and
masquerade the local network packet formatted according to the local network protocol used to communicate between the assistant device and the plurality of appliances into the Internet packet formatted according to the Internet protocol used to communicate between Internet connected devices by storing the local network packet into a data portion of the Internet packet, and storing an Internet address associated with the second device in a header portion of the Internet packet.

20. The system of claim 13, comprising a processor associated with the assistant device configured by second executable instructions to:
determine that an assistant device display cannot present an adaptable user interface above a predefined minimum readability requirement defining a set of criteria regarding the adaptable user interface that must be satisfied before the adaptable user interface can be displayed;
separate the adaptable user interface into a first page and a second page, wherein the first page and the second page satisfy the predefined minimum readability requirement; and
present the first page on a second device display along with an indication of an existence of the second page.

21. The system of claim 13, comprising a processor associated with the assistant device configured by second executable instructions to:
receive a user interface element in a plurality of user interface elements having a changed size;
determine that a layout of an adaptable user interface including the changed size of the user interface element at least partially truncates one or more user interface elements in the user interface elements;
separate the adaptable user interface into a first page and a second page, wherein the first page and the second page satisfy a predefined minimum readability requirement; and
present the first page on a second device display along with an indication of an existence of the second page.
